(19) United States
(12) Patent Application Publication
(10) Pub. No.: US 2012/0066676 A1
(43) Pub. Date: Mar. 15, 2012

(54) DISABLING CIRCUITRY FROM INITIATING MODIFICATION, AT LEAST IN PART, OF STATE-ASSOCIATED INFORMATION

(76) Inventors: Yao Zu Dong, Shanghai (CN); Kun Tian, Shanghai (CN); Yunhong Jiang, Shanghai (CN)

(21) Appl. No.: 12/878,772

(22) Filed: Sep. 9, 2010

(51) Int. Cl. G06F 9/455; G06F 12/00

(52) U.S. Cl. 718/1; 711/165; 711/E12.001

(57) ABSTRACT

An embodiment may include circuitry to be comprised at least in part in a first host, and being enabled, when the circuitry is in a first mode of operation, to modify, at least in part, first information maintained, at least in part, by the circuitry and associated, at least in part, with at least one operational state. The circuitry may be disabled from initiating modification to the first information when the circuitry is in a second mode. The circuitry may enter the second mode in response to at least one command. When in the second mode, the circuitry may (1) copy, at least in part, the first information to at least one memory region, (2) replace, at least in part, the first information with second information, and (3) enter at least another operational state associated, at least in part, with the second information.

### FIELD

This disclosure relates to disabling circuitry from initiating modification, at least in part, of information associated, at least in part, with at least one state of the circuitry.

### BACKGROUND

In one conventional virtualization arrangement, a computer executes virtualization software and operating systems. The computer includes physical hardware resources that are shared by the virtualization software among the operating systems. The resulting shared resources may be associated with the operating systems as virtual machines. As can be appreciated, the virtualization software imposes processing and latency overhead. This reduces performance. In an effort to reduce such overhead, certain virtualization software permits a pass through mechanism whereby at least some of the physical hardware resources may be directly assigned to and accessed by one or more operating systems in a manner that bypasses the virtualization software.

One perceived benefit of virtualization is the relative ease with which a given virtual machine may be relocated from one physical computer to another physical computer, with little to no service down time. This largely results from the ability of the virtualization software to copy and restore respective virtual machine states between given virtual machines.

However, this presupposes that the virtualization software maintains current information concerning and is able to control the internal states of the physical hardware resources. Therefore, the use of pass through mechanisms complicates this process. This is because, by design, interactions between the pass through hardware resource and the operating system assigned to the resource, and control of the resource itself, bypass the virtualization software. Therefore, the internal states of the hardware resource may be unknown or unavailable to the virtualization software, and/or the internal states may be changing and/or subject to change during the migration process.

It has been proposed to use teamed hot plug pass through devices as a solution to the above problems. In this proposed solution, a physical pass through resource is bound to a software virtualized device using a teaming driver mechanism in the operating system. The pass through resource may be hot plugged off from the operating system, before migration, via a virtual or physical hot plug event. Unfortunately, in addition to involving use of operating system hot plug features, this proposed solution also suffers to the disadvantage of being relatively slow to execute.

Another proposed solution also involves use of another type of operating system driver, and suffers from similar disadvantages. Yet another proposed solution involves placing the virtualization software into an emulation mode that is tailored to the specific physical resource involved in the migration. Given the many different types, functions, features, and operations of physical resources that could potentially be involved in migration operations, this greatly complicates design of the virtualization software.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates an embodiment.

FIG. 2 illustrates elements of an embodiment.

FIG. 3 illustrates operations and states in an embodiment.

FIG. 4 illustrates operations in an embodiment.

FIG. 5 illustrates an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

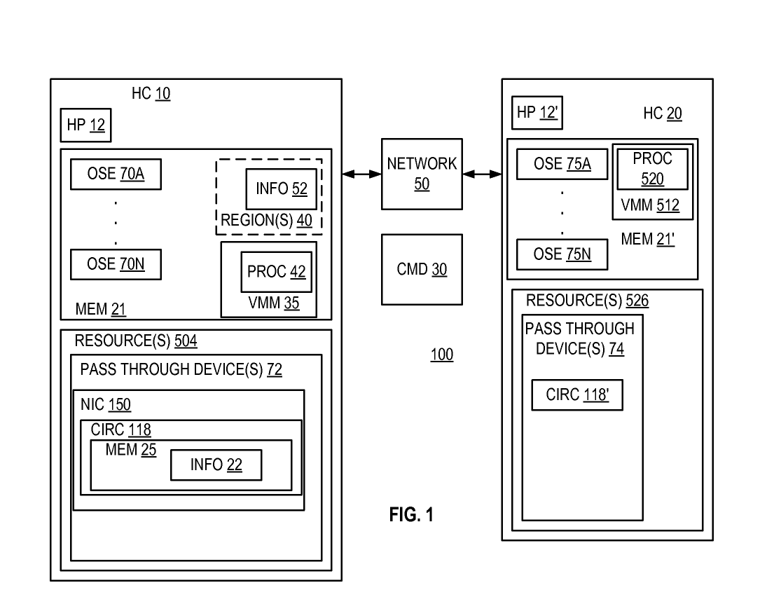

FIG. 1 illustrates a system embodiment 100. System 100 may include host computers (HC) 10 and 20 that may be communicatively coupled together via one or more wireless and/or wired networks 50. In this embodiment, the terms “host computer,” “host,” “server,” and “node” may be used interchangeably, and may mean, for example, one or more end stations, smart phones, tablet computers, appliances, intermediate stations, network interfaces, clients, servers, and/or portions thereof. In this embodiment, a “network” or “communication link” may be used interchangeably, and may be or comprise any mechanism, instrumentality, modality, and/or portion thereof that permits, facilitates, and/or allows, at least in part, two or more entities to be communicatively coupled together. Also in this embodiment, a first entity may be “communicatively coupled” to a second entity if the first entity is capable of transmitting to and/or receiving from the second entity one or more commands and/or data. In this embodiment, a “wireless network” means a network that permits, at least in part, at least two entities to be wirelessly communicatively coupled, at least in part. In this embodiment, a “wired network” means a network that permits, at least in part, at least two entities to be communicatively coupled, at least in part, via non-wireless means, at least in part. In this embodiment, data may be or comprise one or more commands (for example one or more program instructions), and/or one or more such commands may be or comprise data. Also in this embodiment, an “instruction” may include data and/or one or more commands.

Host computer 10 may comprise one or more single and/or multi-core host processors (HP) 12 and computer-readable/writable memory 21. Although not shown in the Figures, host computer 10 also may comprise one or more chipsets (comprising, e.g., memory and/or input/output controller circuitry). One or more host processors 12 may be communicatively coupled via the one or more chipsets to memory 21 and one or more resources 504. One or more resources 504 may comprise one or more pass through devices 72.

One or more pass through devices 72 may comprise network interface and/or input/output (I/O) controller circuitry (NIC) 150. In an embodiment, network and/or I/O controller circuitry may be or comprise circuitry capable of monitoring, facilitating, controlling, permitting, and/or implementing, at least in part, transmission, storage, retrieval, and/or reception, at least in part, of one or more symbols and/or values. Circuitry 150 may be communicatively coupled to host computer 20 via one or more networks 50. Additionally or alternatively, NIC 150 may be or comprise storage, mass storage, and/or disk storage controller circuitry. In this embodiment, circuitry 150 may comprise circuitry 118. Circuitry 118 may comprise, for example, computer readable/writable memory 25.

Alternatively or additionally, although not shown in the Figures, some or all of circuitry 150, 118, and/or the functionality and components thereof may be comprised in, for example, one or more host processors 12 and/or the one or more not shown chipsets. Also alternatively, one or more host processors 12, memory 21, the one or more not shown chipsets, and/or some or all of the functionality and/or components thereof may be comprised in, for example, circuitry 150 and/or circuitry 118. Many other alternatives are possible without departing from this embodiment.

Depending upon, for example, the particular embodiment, host 20 may comprise, in whole or in part, respective components and/or functionality that may be similar to the respective components and/or functionality of host 10. However, alternatively or additionally, host 20 may comprise, at least in part, respective components and/or functionality that may differ, at least in part, from respective components and/or functionality of host 10. For example, host computer 20 may comprise one or more host processors 12′, memory 21′, one or more pass through devices 74, and/or circuitry 118′ that may be generally similar in respective function and/or respective operation, at least in part, to one or more host processors 12, memory 21, one or more devices 72, and/or circuitry 118.

As used herein, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry. Also in this embodiment, a processor, processor core, core, and controller each may comprise respective circuitry capable of performing, at least in part, one or more arithmetic and/or logical operations, such as, for example, one or more respective central processing units. Also in this embodiment, a chipset may comprise circuitry capable of communicatively coupling, at least in part, one or more host processors, storage, mass storage, one or more nodes, and/or memory. Although not shown in the Figures, host computer 10 and/or host computer 20 each may comprise a respective graphical user interface system. The not shown respective graphical user interface systems may comprise, e.g., respective keyboards, pointing devices, and display systems that may permit one or more human users to input commands to, and monitor the operation of, host computer 10, node 20, and/or system 100.

One or more machine-readable program instructions may be stored in computer-readable/writable memory 21 and/or 25. In operation of host computer 10, these instructions may be accessed and executed by one or more host processors 12, one or more devices 72, NIC 150, and/or circuitry 118. When executed by one or more host processors 12, one or more devices 72, NIC 150, and/or circuitry 118, these one or more instructions may result in one or more operating system environments (OSE) 70A . . . 70N, and/or one or more virtual machine monitors (VMM) 35 being executed at least in part by one or more host processors 12 and becoming resident at least in part in memory 21. Also when executed by one or more host processors 12, one or more devices 72, NIC 150, and/or circuitry 118, these one or more instructions may result in one or more host processors 12, one or more devices 72, NIC 150, circuitry 118, one or more OSE 70A . . . 70N, and/or one or more VMM 35, performing the operations described herein as being performed by these components of system 100. In this embodiment, a portion of an entity may comprise all or less than all of the entity. In this embodiment, an operating system environment or guest operating system environment may be used interchangeably and may comprise one or more portions of one or more operating systems and/or one or more applications. Also in this embodiment, a virtual machine monitor may comprise, at least in part, one or more processes capable of monitoring and/or controlling, at least in part, operation of one or more operating system environments, such as, for example, one or more hypervisor processes. Also, in this embodiment, a process, program, driver, operating system, and application may be used interchangeably, and may comprise and/or result at least in part from execution of one or more program instructions and/or software threads. Although not shown in the Figures, one or more processes 42 may be comprised, at least in part, in one or more virtual machine monitors 42, or vice versa. Also in this embodiment, memory 21 and/or memory 25 may comprise one or more of the following types of memories: semiconductor firmware memory, programmable memory, non-volatile memory, read only memory, electrically programmable memory, random access memory (such as, for example, dynamic and/or static random access memory), flash memory, magnetic disk memory, optical disk memory, register memory, cache memory, memory to store state information, and/or other or later-developed computer-readable and/or writable memory. Also, in this embodiment, a resource may comprise, at least in part, circuitry and/or one or more processes, such as, without limitation, one or more I/O resources and/or memory. Additionally, in this embodiment, a pass through device may comprise, at least in part, a resource that is capable of being accessed and/or controlled, at least in part, by at least one portion of an operating system environment in such a way that involvement of a virtual machine monitor in such access and/or control is bypassed, at least in part.

In this embodiment, a state or operational state of an entity may be used interchangeably, and may be or comprise, at least in part, (1) internal or external contents, context, condition, operation, function, attribute, instrumentality, calculation and/or activity of, being executed by, executable by, and/or associated with, at least in part, the entity, and/or (2) data and/or information describing, related to, involved in, comprised in, associated with, useful for, facilitating, and/or based upon, directly or indirectly, at least in part, such contents, context, condition, operation, function, attribute, instrumentality, calculation, and/or activity. Particular examples of states and/or state information in this embodiment may include software, hardware, process, communication, protocol, and input/output context information, value of in-flight and/or intermediate calculations, iterative convergence and/or equation variable-related data, open files and/or connections, etc. Also, in this embodiment, a mode of operation of an entity may result from, be associated with, comprise, and/or involve, at least in part, one or more states of the entity.

One or more machine-readable program instructions may be stored in computer-readable/writable memory 21′. In operation of host computer 20, these instructions may be accessed and executed by one or more host processors 12′, one or more devices 74, one or more resources 526, and/or circuitry 118′. When executed by one or more host processors 12′, one or more devices 74, one or more resources 526, and/or circuitry 118′, these one or more instructions may result in one or more OSE 75A . . . 75N, and/or one or more VMM 512 being executed at least in part by one or more host processors 12′ and becoming resident at least in part in memory 21′. Also when executed by one or more host processors 12′, one or more devices 74, one or more resources 526, and/or circuitry 118′, these one or more instructions may result in one or more host processors 12′, one or more devices 74, one or more resources 526, circuitry 118′, one or more OSE 75A . . . 75N, and/or one or more VMM 512, performing the operations described herein as being performed by these components of system 100. In this embodiment, one or more VMM 526 may comprise one or more processes 520.

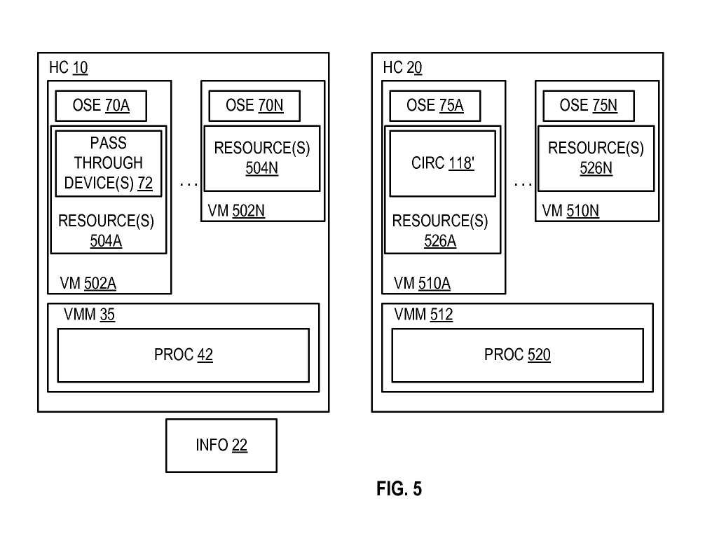

With reference now being made to FIG. 5, in operation of system 100, the execution of one or more VMM 35 may result, at least in part, in host 10 comprising, at least in part, one or more (and in this embodiment, a plurality of) virtual machines (VM) 502A . . . 502N. For examples, one or more VM 502A may comprise one or more OSE 70A, and one or more resources 504A that may be accessible and/or controllable, at least in part, by one or more OSE 70A. One or more VM 502N may comprise one or more OSE 70N, and one or more resources 504N that may be accessible and/or controllable, at least in part, by one or more OSE 70N. In this embodiment, one or more resources 504A may comprise, at least in part, one or more pass through devices 72 that may be directly accessed and/or controlled, at least in part, by at least one portion of OSE 70A (e.g., so as to avoid and/or bypass, at least in part, involvement of VMM 35 in such access and/or control). In this embodiment, a virtual machine may comprise, at least in part, one or more operating system environments and one or more resources accessible and/or controllable at least in part by the one or more operating system environments.

Also, in operation of system 100, the execution of one or more VMM 512 may result, at least in part, in host 20 comprising, at least in part, one or more (and in this embodiment, a plurality of) VM 510A . . . 510N. For examples, one or more VM 510A may comprise one or more OSE 75A, and one or more resources 526A that may be accessible and/or controllable, at least in part, by one or more OSE 75A. One or more VM 510N may comprise one or more OSE 75N, and one or more resources 526N that may be accessible and/or controllable, at least in part, by one or more OSE 75N. In this embodiment, one or more resources 526A may comprise, at least in part, circuitry 118′.

As shown in FIGS. 1 and 5, VMM 35 and VMM 512 may comprise, at least in part, separate entities residing and/or operating in hosts 10 and 20, respectively. However, without departing from this embodiment, VMM 35 and VMM 512 may comprise, at least in part, one or more common entities that may reside, for example, in host 10, host 20, and/or one or more not shown hosts (e.g., one or more administrative host computers) that may be communicatively coupled to host 10 and/or host 20.

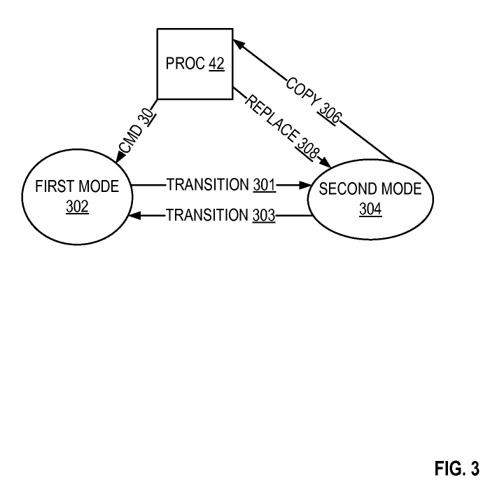

As a result, at least in part, of one or more commands issued to host computer 10, host computer 20, and/or system 100 (e.g., via the one or more not shown user interfaces), one or more processes 42 may issue, at least in part, to circuitry 118 one or more commands (CMD) 30 (see FIGS. 1 and 3). These one or more commands 30 may be for the purpose of facilitating, implementing, and/or initiating migration, at least in part, of one or more portions of one or more virtual machines (e.g., one or more VM 502A) from host 10 to host 20. The one or more commands 30 may be implemented, at least in part, by, for example, writing to one or more registers (not shown) in circuitry 118 and/or initiating one or more direct memory access.

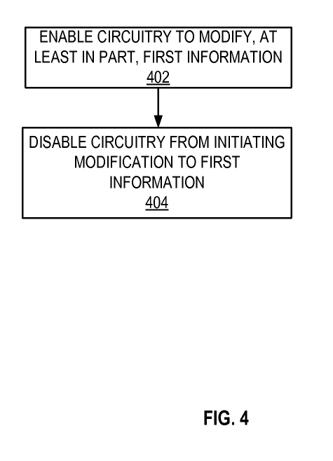

Prior to receiving, at least in part, one or more commands 30, circuitry 118 may operate in a first mode of operation 302 in which circuitry 118 may be enabled to modify, at least in part, information 22 that may be maintained, at least in part, by circuitry 118, as illustrated by operation 402 in FIG. 4. While in this first mode of operation, one or more resources 504A may comprise, at least in part, the one or more pass through devices 72 that may be directly accessed and/or controlled, at least in part, by at least one portion of OSE 70A. Information 22 may be stored, at least in part, in memory 25 in circuitry 118 and may be associated, at least in part, with one or more current, past, and/or anticipated future operational states of circuitry 118. When this information 22 is stored, at least in part, in memory 25, this may result, at least in part, in circuitry 118 operating in this first mode of operation, and in one or more resources 504A comprising, at least in part, the one or more pass through devices 72 (e.g., comprising, at least in part, NIC 150 and/or circuitry 118) that may be directly accessed and/or controlled, at least in part, by at least one portion of OSE 70A. Thus, in this first mode of operation, guest OSE 70A may utilize, at least in part, NIC 150, one or more resources 504A, and/or circuitry 118 as one or more pass through devices. Memory 25 may comprise, at least in part, one or more control and/or other registers and/or memory locations in circuitry 118 whose contents may control and/or reflect, at least in part, these one or more operational states of circuitry 118. During the course of operating in mode 302, circuitry 118 may modify, at least in part, information 22 to reflect, at least in part, for example, one or more changes to these one or more operational states that may occur and/or result from, at least in part, the operation of circuitry 118 in mode 302.

In response, at least in part, to one or more commands 30, circuitry 118 may undergo a transition 301 to and enter a second mode of operation 304 (see FIG. 3). Of course, without departing from this embodiment, depending upon the particular implementation, the second mode of operation 304 may co-exist, at least in part, with one or more other and/or additional modes of operation (e.g., that may be different at least in part from mode 302). When circuitry 118 is in mode 304, circuitry 118 may be disabled from initiating modification to the information 22, as illustrated by operation 404 in FIG. 4. Also when circuitry 118 is in this second mode 304, circuitry 118 may copy, at least in part, information 22 to one or more memory regions 40, for use at least in part by one or more processes 42, as illustrated by operation 306 in FIG. 3. Alternatively or additionally, one or more HP 12 may read, at least in part, information 22 and may store, at least in part, information 22 in one or more regions 40, for use at least in part by one or more processes 42. Accordingly, in this embodiment, operation 306 should be viewed as encompassing either or both of these possibilities. Additionally, while circuitry 118 is in mode 304, circuitry 118 may obtain, at least in part, other information 52 (shown in FIG. 1) from one or more regions 40, and may replace (e.g., overwrite), at least in part, information 22 stored in memory 25 with information 52, as illustrated by operation 308 in FIG. 3. Prior to circuitry 118 obtaining, at least in part, information 52 from one or more regions 40, one or more processes 42 may provide, at least in part, information 52, and information 52 may be stored, at least in part, in one or more regions 40. After circuitry 118 has executed, at least in part, operation 308, circuitry 118 may undergo transition 303 back to mode 302 from mode 304, and may re-enter mode 302. After circuitry 118 has re-entered mode 302, as a result, at least in part, of the replacing, at least in part, of information 22 with information 52 in memory 25, circuitry 118 may enter one or more other (e.g., new and/or different) operational states associated, at least in part, with the second information. This may facilitate and/or implement, at least in part, migration, at least in part, of one or more VM 502A, and/or re-assignment, at least in part, of one or more resources 504A and/or circuitry 118 to one or more other virtual machines (e.g., one or more VM 502N) in host 10. In this embodiment, such migration may include, for example, so-called “live migration” in which there may be relatively little service downtime, or non-live migration that may involve saving and restoring states/state information. Additionally or alternatively, in this embodiment, such live migration may involve the use of checkpointing such that only one or more state changes since a last checkpoint may be transported, in order to permit relatively rapid state cloning to be implemented. Also, in this embodiment, such re-assignment does not necessarily presume that (1) the virtual machines involved in such re-assignment are identical and/or (2) one or more states of the one or more resources involved in the re-assignment are identical before and after the re-assignment.

For example, as shown in FIG. 5, in migrating, at least in part, one or more VM 502A from host 10 to host 20, information associated, at least in part, with one or more states of VM 502A (including, for example, information 22 after information 22 has been stored, at least in part, in one or more regions 40) may be transferred, at least in part, to host 20 by one or more processes 42 via, e.g., one or more networks 50. Additionally, in migrating, at least in part, one or more VM 502A from host 10 to host 20, the information 52 that may be provided, at least in part, by one or more processes 42, may result, at least in part, in circuitry 118, one or more resources 504A, and/or NIC 150 becoming, at least in part, associated with VM 502N as one or more pass through devices of guest OSE 70N, after circuitry 118 has replaced, at least in part, information 22 with information 52 in memory 25. That is, information 52 may be generated so as to result, at least in part, in circuitry 118, one or more resources 504A, and/or NIC 150 operating, at least in part, as one or more pass through devices that are controlled and/or accessible by one or more guest OSE 70N, after information 52 has replaced information 22 in memory 25. Thus, as a result, at least in part, of these operations, circuitry 118, one or more resources 504A, and/or NIC 150 may be re-assigned, at least in part, by VMM 35 from comprising or being comprised in, at least in part, one or more pass through devices associated, at least in part, with guest OSE 70A in VM 502A, to operate, at least in part, as one or more pass through devices associated, at least in part, with guest OSE 70N in VM 502N in host 10.

Also, for example, in migrating, at least in part, one or more VM 502A from host 10 to host 20, one or more processes 520 in VMM 512 may utilize, at least in part, the information transferred, at least in part, by one or more processes 42 to establish, make resident, and/or permit to be executed, at least in part, in host 20, one or more VM 502A. For example, one or more processes 520 may store information 22 in one or more not shown memory regions in host 20. Circuitry 118′ in host 20 may replace, at least in part, current state information (not shown) in circuitry 118′ with information 22. As a result, at least in part, of circuitry 118′ so replacing, at least in part, this current state information with information 22, circuitry 118′ and/or one or more resources 526A may enter the one or more operating states that circuitry 118 was operating in immediately prior to receiving one or more commands 30. These operations may result, at least in part, in VM 502A becoming resident and/or being executed in host 20, and in circuitry 118′ and/or one or more resources 526A becoming, at least in part, associated with VM 502A as one or more pass through devices of guest OSE 70A in host 20. Thus, as a result, at least in part, of these operations, circuitry 118′ and/or one or more resources 526A may be re-assigned, at least in part, by VMM 512 to operate, at least in part, as one or more pass through devices associated, at least in part, with guest OSE 70A in VM 502A in host 20.

In this embodiment, circuitry 118 may perform operations 306 and/or 308, at least in part, via one or more direct memory access operations. For example, information 22 may be transferred, at least in part, by circuitry 118 to one or more regions 40 via direct memory access. Also, for example, information 52 may be transferred, at least in part, by circuitry 118 from one or more regions 40 via one direct memory access. Alternatively or additionally, the transfers of information 22 and/or 52 may be accomplished at least in part via, for example, one or more memory reads carried out by one or more HP 12 and/or one or more processes 42. Further alternatively or additionally, such transfers may be accomplished, at least in part, by a combination of memory read/write operations. For example, one or more processes 42 may export to NIC 150 one or more internal addresses and/or data sizes to be read, and NIC 150 may return to one or more processes 42 the data satisfying these addresses and/or data sizes in a subsequent read thereof by one or more processes 42. Of course, other memory transfer techniques may be utilized without departing from this embodiment. Accordingly, operation 306 and/or operation 308 should be viewed as encompassing all such possible memory transfer techniques.

Also in this embodiment, in response, at least in part, to one or more commands 30, circuitry 118 may execute transition 301, operation 306, operation 308, and/or transition 303 in a single atomic operation. Thus, for example, this single atomic operation may comprise entry by the circuitry 118 into the second mode 304 from the first mode 302, copying, at least in part, of information 22 to the one or more regions 40, and/or replacing, at least in part, information 22 in memory 25 with information 52. In this embodiment, an atomic operation may comprise a plurality of operations intended to be executed completely, and as a single transaction.

In this embodiment, when circuitry 118 is operating in the second mode 304, one or more internal states (e.g., one or more states related to the migration) of circuitry 118 may no longer be capable of being changed, except via operation 308. Additionally, in this embodiment, transition 301 and/or transition 303 may be achieved, at least in part, via one or more relatively fast internal state changes (e.g., involving circuitry 118). In this embodiment, when circuitry 118 transitions to mode 304, one or more not shown in-process packets and/or contents of one or more not shown internal packet first-in-first-out buffers may be dropped and/or flushed. Also, in this embodiment, when circuitry 118 transitions to mode 304, one or more on-going direct memory access operations may be terminated or suspended until circuitry 118 returns to mode 302.

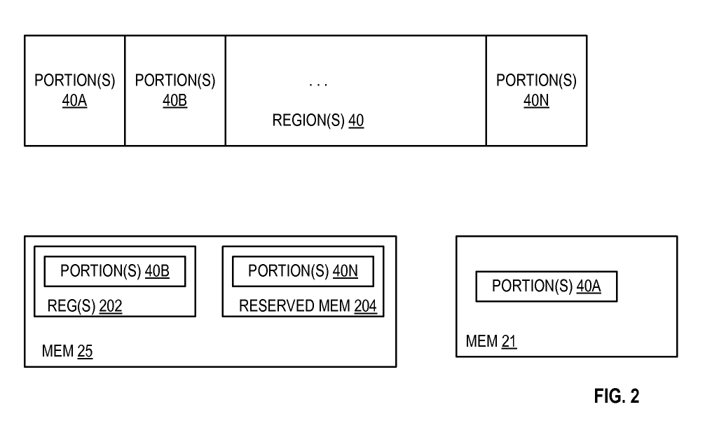

Additionally, with reference to FIG. 2, in this embodiment, one or more memory regions 40 may be comprised, at least in part, in host system memory 21, one or more internal state registers 202 (e.g., in memory 25) in circuitry 118, and/or reserved memory 204 (e.g., in memory 25). For example, one or more regions 40 may comprise one or more (and in this embodiment, a plurality of) portions 40A, 40B, . . . 40N. One or more portions 40A may be comprised in memory 21, one or more portions 40B may be comprised in one or more registers 202, and/or one or more portions 40N may be comprised in reserved memory 204. In this embodiment, one or more registers 202 may comprise one or more registers used to read and/or write one or more internal states of circuitry 118. Also in this embodiment, one or more portions 40A may be stored in one or more predetermined buffers in system memory 21 allocated by, for example, one or more processes 42. Reserved memory 204 may comprise, for example, a reserved and/or predetermined base address region in memory 25. As stored in and/or written to memory 25, circuitry 118′, and/or one or more regions 40, information 22 and/or information 52 may be encrypted, at least in part, for example, by circuitry 118, one or more HP 12, one or more HP 12′, one or more processes 520, one or more processes 42, and/or one or more other components of system 100, as appropriate. In this embodiment, such encrypted information may be decryptable, at least in part, by one or more VMM for further processing. Alternatively, the one or more VMM may be unable to decrypt such encrypted information, and may assign it to one or more devices 72 for decryption, at least in part, by circuitry 118. Advantageously, this may improve the security of information 22, information 52, VM execution, and/or the VM migration in this embodiment.

Also, although not shown in the Figures, NIC 150 may be or comprise a circuit card to be coupled to a circuit board that may include, for example, HP 12, memory 21, and/or the one or more not shown chipsets in host 10. Additionally or alternatively, NIC 150 may be comprised, at least in part, in one or more not shown integrated circuit chips. Further additionally or alternatively, NIC 150 may comprise, at least in part, one or more virtual functions that comply and/or are compatible, at least in part, with “Single Root I/O Virtualization and Sharing Specification,” Revision 1.0, Sep. 11, 2007, PCI-SIG, Beaverton, Oreg., USA.

Thus, an embodiment may include circuitry to be comprised at least in part in a first host, and being enabled, when the circuitry is in a first mode of operation, to modify, at least in part, first information maintained, at least in part, by the circuitry and associated, at least in part, with at least one operational state. The circuitry may be disabled from initiating modification to the first information when the circuitry is in a second mode. The circuitry may enter the second mode in response to at least one command. When in the second mode, the circuitry may (1) copy, at least in part, the first information to at least one memory region, (2) replace, at least in part, the first information with second information, and (3) enter at least another operational state associated, at least in part, with the second information.

Advantageously, in this embodiment, relocation and/or migration of a virtual machine from one physical host to another physical host may be carried out more easily, with little or no service down time, despite use by the virtual machine of one or more pass through devices. This may result, at least in part, from, among other things, the disabling of the circuitry 118, when in the second mode of operation 304, from being able to initiate modification to information 22. This may freeze modification to such information 22 in this embodiment until after circuitry 118 carries out an atomic operation that copies information 22 to one or more regions 40 (e.g., as a result of operation 306), replaces, at least in part, information 22 with information 52 in memory 25, and re-enters the first mode of operation 302. Thus, in this embodiment, information 22 may be available to one or more processes 42 of VMM 35 to implement the relocation and/or migration. Additionally, the VM migration and/or relocation in this embodiment is relatively fast to execute, and does not necessarily involve a virtual or physical hot plug event, the guest operating system environment to carry out the migration and/or relocation, and placing the virtualization software into an emulation mode.

Many modifications, alternatives, and variations are possible without departing from this embodiment. Accordingly, the claims should be viewed broadly as encompassing all such modifications, alternatives, and variations.

What is claimed is:

1. An apparatus comprising:
circuitry to be comprised, at least in part, in a first host, the circuitry having at least one operational state, the circuitry being enabled, when the circuitry is in a first mode of operation, to modify, at least in part, first information maintained, at least in part, by the circuitry and associated, at least in part, with the at least one operational state, the circuitry being disabled from initiating modification to the first information when the circuitry is in a second mode of operation, the circuitry being to enter the second mode of operation in response to at least one command, the circuitry being to copy, at least in part, the first information to at least one memory region when the circuitry is in the second mode of operation, the circuitry also being to replace, at least in part, the first information maintained, at least in part, by the circuitry with second information when the circuitry is in the second mode of operation and to enter at least another operational state associated, at least in part, with the second information.

2. The apparatus of claim 1, wherein:
the apparatus comprises the first host and a second host;
the first host comprises a first guest operating system environment to utilize, at least in part, the circuitry as at least one pass through device; and
the second host comprises other circuitry and a second guest operating system environment, the second guest operating system environment to utilize, at least in part, the other circuitry as at least one other pass through device, the other circuitry being to receive, at least in part, the first information and to enter, at least in part, the at least one operational state.

3. The apparatus of claim 1, wherein:
the at least one memory region is at least one of:
comprised, at least in part, in host system memory in the first host;
comprised, at least in part, in at least one internal state register in the circuitry; and
comprised, at least in part, in reserved memory the circuitry; and
the at least one memory region is to store, at least in part, the second information prior to replacing by the circuitry of the first information with the second information.

4. The apparatus of claim 1, wherein:
the first host comprises at least one host processor and a network interface controller;
the at least one host processor is to execute, at least in part, at least one virtual machine monitor and at least one guest operating system environment;
the network interface controller comprises, at least in part, the circuitry; and
when the circuitry is in the first mode of operation, the at least one guest operating system environment is to utilize, at least in part, the controller as at least one pass through device.

5. The apparatus of claim 4, wherein:
the at least one command is to be issued, at least in part, by at least one process comprised, at least in part, in the at least one virtual machine monitor;
the at least one process is to obtain, at least in part, the first information from the at least one memory region; and
the at least one process is to provide, at least in part, the second information for storage to the at least one memory region.

6. The apparatus of claim 5, wherein:
at least one of the first information and the second information is to be transferred to and from the at least one memory region via direct memory access; and
in response, at least in part, to the at least one command, the circuitry executes an atomic operation that comprises:
entry into the second mode of operation from the first mode of operation;
copying, at least in part, of the first information to the at least one memory region; and
replacing, at least in part, the first information maintained, at least in part, by the circuitry with the second information from the at least one memory region.

7. A method comprising:
enabling circuitry, when the circuitry is in a first mode of operation, to modify, at least in part, first information maintained, at least in part, by the circuitry and associated, at least in part, with at least one operational state of the circuitry, the circuitry to be comprised, at least in part, in a first host; and
disabling the circuitry from initiating modification to the first information when the circuitry is in a second mode of operation, the circuitry being to enter the second mode of operation in response to at least one command, the circuitry being to copy, at least in part, the first information to at least one memory region when the circuitry is in the second mode of operation, the circuitry also being to replace, at least in part, the first information maintained, at least in part, by the circuitry with second information when the circuitry is in the second mode of operation and to enter at least another operational state associated, at least in part, with the second information.

8. The method of claim 7, wherein:
the first host comprises a first guest operating system environment to utilize, at least in part, the circuitry as at least one pass through device; and
a second host comprises other circuitry and a second guest operating system environment, the second guest operating system environment to utilize, at least in part, the other circuitry as at least one other pass through device, the other circuitry being to receive, at least in part, the first information and to enter, at least in part, the at least one operational state.

9. The method of claim 7, wherein:
the at least one memory region is at least one of:
comprised, at least in part, in host system memory in the first host;
comprised, at least in part, in at least one internal state register in the circuitry; and
comprised, at least in part, in reserved memory the circuitry; and
the at least one memory region is to store, at least in part, the second information prior to replacing by the circuitry of the first information with the second information.

10. The method of claim 7, wherein:
the first host comprises at least one host processor and a network interface controller;
the at least one host processor is to execute, at least in part, at least one virtual machine monitor and at least one guest operating system environment;
the network interface controller comprises, at least in part, the circuitry; and
when the circuitry is in the first mode of operation, the at least one guest operating system environment is to utilize, at least in part, the controller as at least one pass through device.

11. The method of claim 10, wherein:
the at least one command is to be issued, at least in part, by at least one process comprised, at least in part, in the at least one virtual machine monitor;
the at least one process is to obtain, at least in part, the first information from the at least one memory region; and
the at least one process is to provide, at least in part, the second information for storage to the at least one memory region.

12. The method of claim 11, wherein:
at least one of the first information and the second information is to be transferred to and from the at least one memory region via direct memory access; and
in response, at least in part, to the at least one command, the circuitry executes an atomic operation that comprises:
entry into the second mode of operation from the first mode of operation;
copying, at least in part, of the first information to the at least one memory region; and
replacing, at least in part, the first information maintained, at least in part, by the circuitry with the second information from the at least one memory region.

13. Computer-readable memory storing one or more instructions that when executed by a machine result in performance of operations comprising:
enabling circuitry, when the circuitry is in a first mode of operation, to modify, at least in part, first information maintained, at least in part, by the circuitry and associated, at least in part, with at least one operational state of the circuitry, the circuitry to be comprised, at least in part, in a first host; and
disabling the circuitry from initiating modification to the first information when the circuitry is in a second mode of operation, the circuitry being to enter the second mode of operation in response to at least one command, the circuitry being to copy, at least in part, the first information to at least one memory region when the circuitry is in the second mode of operation, the circuitry also being to replace, at least in part, the first information maintained, at least in part, by the circuitry with second information when the circuitry is in the second mode of operation and to enter at least another operational state associated, at least in part, with the second information.

14. The computer-readable memory of claim 13, wherein:
the first host comprises a first guest operating system environment to utilize, at least in part, the circuitry as at least one pass through device; and
a second host comprises other circuitry and a second guest operating system environment, the second guest operating system environment to utilize, at least in part, the other circuitry as at least one other pass through device, the other circuitry being to receive, at least in part, the first information and to enter, at least in part, the at least one operational state.

15. The computer-readable memory of claim 13, wherein:
the at least one memory region is at least one of:
comprised, at least in part, in host system memory in the first host;
comprised, at least in part, in at least one internal state register in the circuitry; and
comprised, at least in part, in reserved memory the circuitry; and
the at least one memory region is to store, at least in part, the second information prior to replacing by the circuitry of the first information with the second information.

16. The computer-readable memory of claim 13, wherein:
the first host comprises at least one host processor and a network interface controller;
the at least one host processor is to execute, at least in part, at least one virtual machine monitor and at least one guest operating system environment;
the network interface controller comprises, at least in part, the circuitry; and
when the circuitry is in the first mode of operation, the at least one guest operating system environment is to utilize, at least in part, the controller as at least one pass through device.

17. The computer-readable memory of claim 16, wherein:
the at least one command is to be issued, at least in part, by at least one process comprised, at least in part, in the at least one virtual machine monitor;
the at least one process is to obtain, at least in part, the first information from the at least one memory region; and
the at least one process is to provide, at least in part, the second information for storage to the at least one memory region.

18. The computer-readable memory of claim 17, wherein:
at least one of the first information and the second information is to be transferred to and from the at least one memory region via direct memory access; and
in response, at least in part, to the at least one command, the circuitry executes an atomic operation that comprises:
entry into the second mode of operation from the first mode of operation;
copying, at least in part, of the first information to the at least one memory region; and
replacing, at least in part, the first information maintained, at least in part, by the circuitry with the second information from the at least one memory region.
